(19) United States
(12) Patent Application Publication
(10) Pub. No.: US 2011/0185136 A1
(43) Pub. Date: Jul. 28, 2011

(54) MOVING LARGE DYNAMIC DATASETS VIA INCREMENTAL CHANGE SYNCHRONIZATION

(75) Inventors: DMITRI GAVRILOV, REDMOND, WA (US); BRADFORD R. CLARK, DUVALL, WA (US); JAMES C. KLEEWEIN, KIRKLAND, WA (US); AYLA KOL, SAMMAMISH, WA (US); BRIAN T. KRESS, WOODINVILLE, WA (US); NARESH SUNDARAM, REDMOND, WA (US)

(73) Assignee: MICROSOFT CORPORATION, REDMOND, WA (US)

(21) Appl. No.: 12/692,321

(22) Filed: Jan. 22, 2010

(51) Int. Cl. G06F 12/16; G06F 12/00

(52) U.S. Cl. 711/162; 711/E12.001; 711/E12.103

(57) ABSTRACT

Incremental change synchronization for moving large data sets may be provided. Source data to be moved may be identified and a snapshot of the data may be created. The data may be moved to a new datastore and a second snapshot may be created. The snapshots may be compared to identify any data elements that have been modified and the modified elements may be copied to the new datastore.

### RELATED APPLICATION

Related U.S. patent application Ser. No. ______ filed on even date herewith entitled “Massive Structured Data Transfer Optimizations for High-Latency, Low-Reliability Networks”, and assigned to the assignee of the present application, is hereby incorporated by reference.

### BACKGROUND

Incremental change synchronizations provide a process for transferring large amounts of dynamic data. In some situations, data sets may need to be moved from one datastore to another. For example, a database for a mail server may need to be moved to new hardware, due to data management policies or a hardware failure. Such a database may be in a constant state of flux, such as where a number of users are frequently accessing their mail data, receiving new mail messages, and moving, responding to, and deleting messages. In conventional systems, moving the data requires locking the database and preventing user access to the data for the entire duration of the move. This can cause problems because such a move may take an unacceptably long downtime during which users are unable to access their data.

### SUMMARY

Incremental change synchronization may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Incremental change synchronization for moving large data sets may be provided. Source data to be moved may be identified and a snapshot of the data may be created. The data may be moved to a new datastore and a second snapshot may be created. The snapshots may be compared to identify any data elements that have been modified and the modified elements may be copied to the new datastore.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing optimized data transfer; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Incremental change synchronization (ICS) for moving large datasets may be provided. Consistent with embodiments of the present invention, the transfer of a large block of data, such as a large (e.g., 10 GB) mailbox comprising potentially hundreds and/or thousands of messages, may be accomplished with reduced downtime. Before the data move begins, a state snapshot of the source mailbox may be made. Then, the mailbox data may be enumerated and copied item by item and/or in batches. Any changes that occur while the data is being copied may be enumerated using ICS at the end of the move, and the changes may be applied to the destination database. The final round of incremental synchronization may be performed while the source mailbox is locked (i.e., protected from modifications).

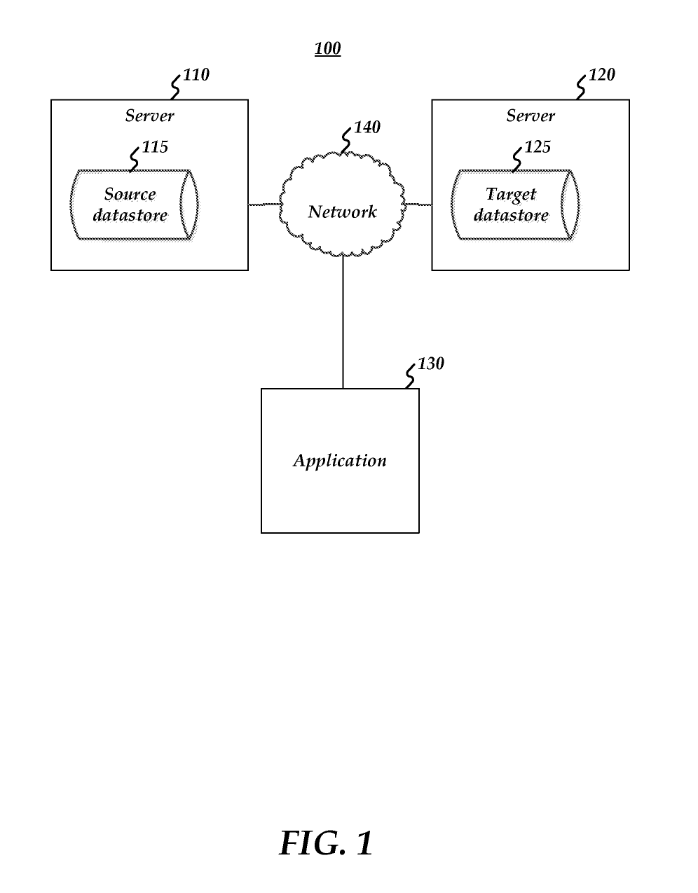

FIG. 1 is a block diagram of an operating environment 100 for providing incremental change synchronization. Operating environment 100 may comprise a first server 110 comprising a source datastore 115 and a second server 120 comprising a target datastore 125. Operating environment 100 may further comprise a client application 130. First server 110, second server 120, and/or client application 130 may communicate over a network 140. Consistent with embodiments of the invention, source datastore 115 and target datastore 125 may be associated with the same server, such as two hard drives on first server 110.

Client application 130 may comprise, for example, a mail application such as Outlook®, as provided by Microsoft® Corporation of Redmond, Wash. The mail application may store a local copy of a mailbox file associated with source datastore 115. First server 110 may be operative as a mail server for receiving and storing messages associated with the server's copy of the mailbox file. Client application 130 may periodically connect to first server 110 to determine whether any changes have occurred to the mailbox file and update the local copy accordingly.

Consistent with embodiments of the invention, ICS may be used to update a local copy of the data associated with source datastore 115 as well as moving the data from one datastore or server to another. In ICS, each element of data may be assigned a sequential change number. For example, when each mail message is received, it may be assigned a change number that is incremented for each message and/or other change made to a data element. A first received message may have a change number, for example, of 4001. A second received message may be assigned a change number of 4002. If a user then modifies the first message, such as by moving it to a different folder within the mailbox file structure, the first message may be assigned a new change number of 4003. The next received message may then be assigned a change number of 4004.

The change numbers may be used to create a snapshot of the state of the data. For example, when a user instantiates client application 130, it may connect to source datastore 115 to create a local copy of the user's associated data. A snapshot of this local copy may comprise a latest change number of any element of the associated data, such as 4004. Client application 130 may then periodically connect to source datastore 115 to determine whether any associated data elements have a later change number than 4004, and retrieve those new or modified elements to update the local copy and create a new snapshot. Consistent with embodiments of the invention, change numbers may be associated with data groupings, such as folders, rather than and/or in addition to individual data elements. For example, each time a message in a folder is added, deleted, moved, or otherwise modified, the change number of the folder may be incremented. In such a case, the snapshot of the data may comprise an array, a hash, a string, and/or a similar structure enumerating the change numbers for all of the folders associated with the data.

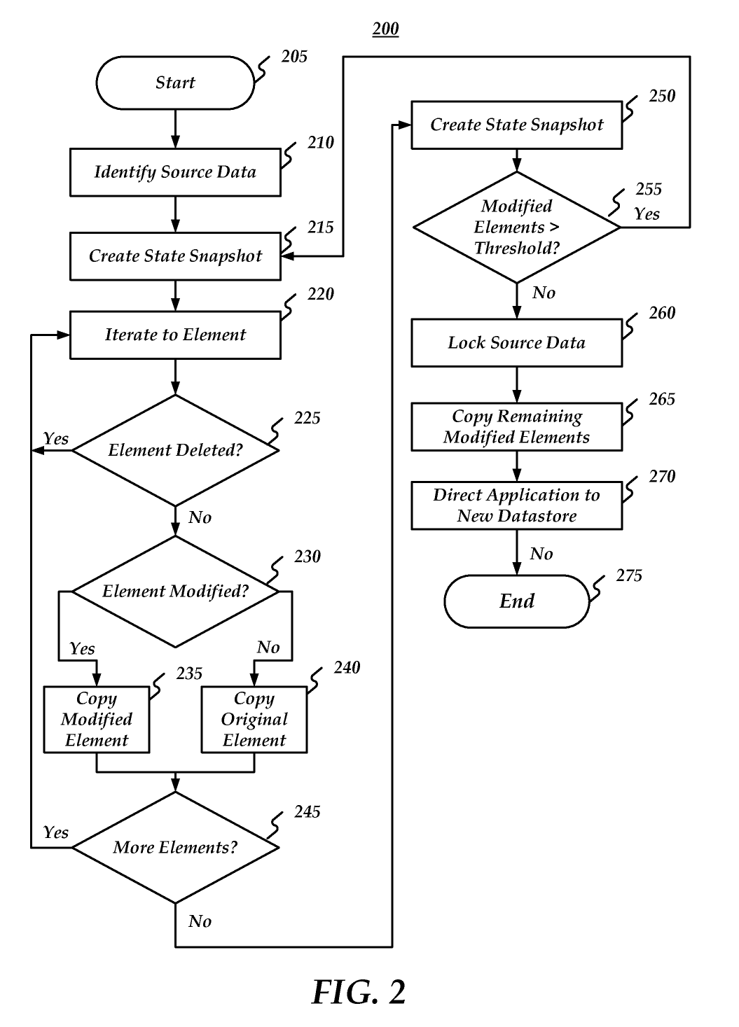

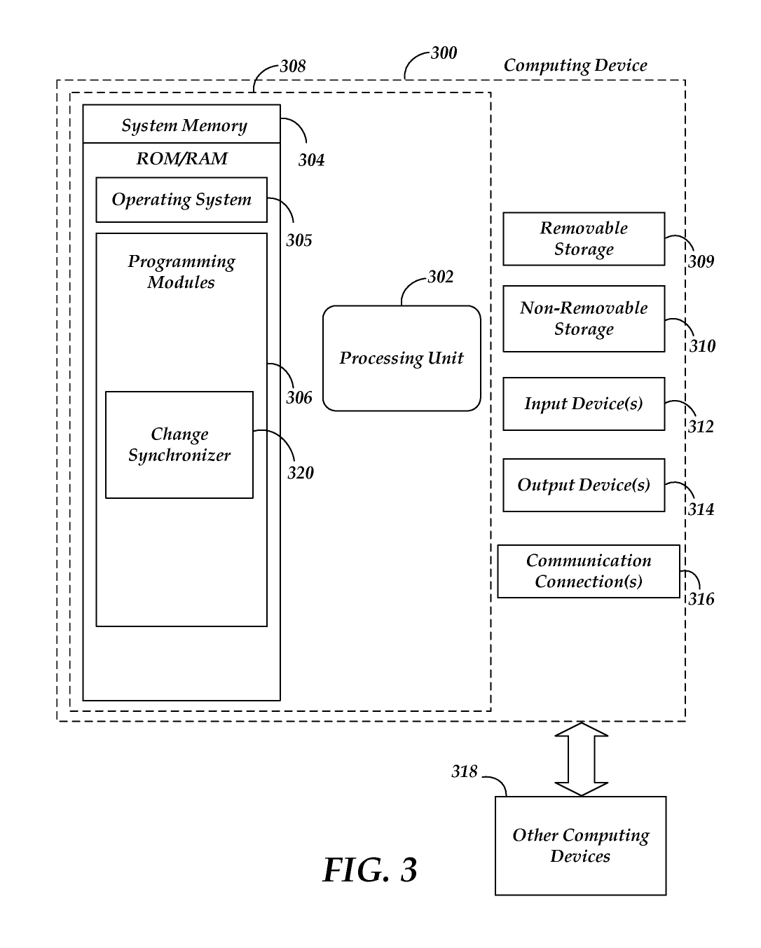

FIG. 2 is a flow chart setting forth the general stages involved in a method 200 consistent with an embodiment of the invention for providing data transfer optimizations. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may identify source data to be moved. For example, first server 110 may identify a mailbox file comprising a plurality of data elements stored in source datastore 115 to be moved to target datastore 125 on second server 120.

From stage 210, method 200 may advance to stage 215 where computing device 300 may create a state snapshot of the identified source data. For example, first server 110 may determine and store a change number associated with a most recently received, modified, moved, and/or deleted data element of the source data.

After creating the initial snapshot at stage 215, method 200 may advance to stage 220 where computing device 300 may iterate through each element of the data in the initial snapshot. At stage 225, computing device 300 may determine whether the data element has been deleted since the snapshot was taken. If so, method 200 may return to stage 220 and iterate to the next element. That is, if an element has been deleted, it may not be copied.

Otherwise, method 200 may advance to stage 230 where computing device 300 may determine whether the data element has been modified since the initial snapshot was taken. For example, a message associated with data comprising a user's mailbox may be moved to another folder. If the element has been modified, method 200 may advance to stage 235 where computing device 300 may copy the element as modified to target datastore 125. Otherwise, method 200 may advance to stage 240 where computing device 300 may copy the original element to target datastore 125.

From stage 235 or stage 240, method 200 may advance to stage 245 where computing device 300 may determine whether any more elements remain to be copied. If so, method 200 may return to stage 220 and iterate to the next data element. Consistent with embodiments of the invention, client access to source datastore 115 may remain active during the copying stages.

Otherwise, method 200 may advance to stage 250 where computing device 300 may create a second snapshot of the source data. For example, the second snapshot may comprise a change number associated with a most recently modified element of the source data, such as an element that was modified during the copy stages 235 and 240.

From stage 250, method 200 may advance to stage 255 where computing device 300 may determine how many data elements changed during the copy stage 235 and 240 and whether the number of changes exceeds a threshold amount. For example, the threshold may comprise 100 changes to elements. If so, method 200 may return to stage 215 and create a new base snapshot. Any changes identified between the new base snapshot and the initial snapshot may then be copied according to the stages described above. Consistent with embodiments of the invention, the second snapshot created at stage 250 may be used as the new base snapshot and method 200 may return to stage 220 to iterate through the changed elements.

Method 200 may then advance to stage 260 where computing device 300 may lock the identified data in source datastore 115. For example, client application 130 may be denied access to source datastore 115 during a periodic update performed by client application 130. Such a denial may comprise an error operative to inform client application 130 that its master data has moved and may comprise data identifying the new location, such as target datastore 125. Consistent with embodiments of the invention, client application 130 may be unable to access data in either source datastore 115 or target datastore 125 while data access is locked. Client application 130 may be operative to periodically retry either and/or both datastores until the lock is removed.

Computing device 300 may also be operative to limit the number of repeating loops from stage 255 to stage 215 or stage 220. That is, if the number of changes exceeds the threshold level on more than some second threshold number of occasions, such as ten, method 200 may proceed onwards to stage 260 rather than repeating indefinitely.

Further consistent with embodiments of the invention, computing device 300 may be operative to determine whether a current time is during a maintenance window before locking access to the data. For example, computing device 300 may only be permitted to lock access between 2:00 AM and 5:00 AM. If the current time is not within such a window, computing device 300 may continue to periodically copy data from source datastore 115 to target datastore 125 according to the stages of method 200 described above until the maintenance window arrives and then lock the data.

From stage 260, method 200 may advance to stage 265 where computing device 300 may copy the remaining modified data elements. For example, in some cases, each iteration of the stages from 215 through 255 may result in less time needed and fewer modified elements to copy until the number of modified elements is below the threshold number. The threshold number may be set so as to minimize the amount of time needed to copy the remaining modified elements and so minimize the amount of time the data is locked from client access.

Once the remaining modified elements are copied in stage 265, method 200 may advance to stage 270 where computing device 300 may direct the client application to the new data location. For example, computing device 300 may send a message to client application 130 directing it to target datastore 125. Consistent with embodiments of the invention, client application 130 may periodically query servers on network 140, such as first server 110 and second server 120, for location information associated with its needed data. In response to such a query, first server 110 and/or second server 120 may reply with the location information needed for client application 130 to access target datastore 125. Method 200 may then end at stage 275.

An embodiment consistent with the invention may comprise a system for moving data. The system may comprise a memory storage and a processing unit coupled to the memory storage. The processing unit may be operative to identify source data, create a first state snapshot of the source data, copy each of the plurality of source data to a destination datastore, create a second state snapshot of the source data, determine whether the second state snapshot comprises at least one element of source data not present in the first state snapshot, and, if so, copy the at least one element of source data not present in the first state snapshot to the destination datastore.

Another embodiment consistent with the invention may comprise a system for copying a block of data. The system may comprise a memory storage and a processing unit coupled to the memory storage. The processing unit may be operative to provide access from a client application to a plurality of data elements, create a first state snapshot of the plurality of data elements on a first data storage device, copy the plurality of data elements from the first data storage device to a second data storage device while continuing to provide access to the plurality of data elements from the client application, create a second state snapshot of the plurality of data elements on the first data storage device, determine, according to a comparison of the first state snapshot and the second state snapshot, whether more than a threshold number of modifications to the plurality of data elements occurred during the copy of the plurality of data elements from the first data storage device to a second data storage device, and, if so, copy the modified data elements from the first data storage device to the second data storage device while continuing to provide access to the plurality of data elements from the client application.

Yet another embodiment consistent with the invention may comprise a system for copying data with change synchronization. The system may comprise a memory storage and a processing unit coupled to the memory storage. The processing unit may be operative to identify source data on a source datastore, create a first state snapshot of the source data, and determine, for each element of the plurality of source data, whether the element has been deleted and/or modified since the creation of the first state snapshot. If the element has been deleted, the processing unit may be operative to skip the element and iterate to the next one. If the element has been modified, the processing unit may be operative to copy the most up to date version of the data element. An unmodified element may be copied in its original state from when the first state snapshot was taken. The processing unit may then be operative to create a second state snapshot of the source data and determine whether the second state snapshot comprises a plurality of data elements greater than a threshold amount not present in the first state snapshot. If so, the processing unit may copy the plurality of modified data elements to the destination datastore. Otherwise, the processing unit may be operative to lock the source datastore from further access by a client application associated with the source data, copy the plurality of data elements to the destination datastore, and direct the client application to access the destination datastore for interaction with the source data.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for system 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, such as a change synchronizer 320. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. change synchronizer 320) may perform processes including, for example, one or more of method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for moving data, the method comprising:
identifying a plurality of source data;
creating a first state snapshot of the source data;
copying each of the plurality of source data to a destination datastore;
creating a second state snapshot of the source data;
determining whether the second state snapshot comprises at least one element of source data not present in the first state snapshot; and
in response to determining that the second state snapshot comprises the at least one element of source data not present in the first state snapshot, copying the at least one element of source data not present in the first state snapshot to the destination datastore.

2. The method of claim 1, further comprising modifying an element of the source data while copying each of the plurality of source data to the destination datastore.

3. The method of claim 2, wherein the modification to the element of the source data comprises at least one of the following: receiving the element of the source data, deleting the element of the source data, and moving the element of the source data.

4. The method of claim 2, further comprising assigning an incremental change number to the modified element of the source data.

5. The method of claim 4, wherein the first state snapshot comprises at least one incremental change number associated with the source data prior to modifying the element of the source data.

6. The method of claim 5, wherein the second state snapshot comprises the assigned incremental change number of the modified element of the source data.

7. The method of claim 6, wherein determining whether the second state snapshot comprises at least one element of source data not present in the first state snapshot comprises determining whether the at least one incremental change number of the first state snapshot differs from the assigned incremental change number of the second state snapshot.

8. The method of claim 1, further comprising determining whether the second state snapshot comprises a number of changes to the source data greater than a threshold.

9. The method of claim 8, wherein the threshold comprises 100 changes.

10. The method of claim 8, further comprising:
in response to determining that the second state snapshot comprises the number of changes to the source data greater than the threshold, copying each of a plurality of data elements associated with the changes to the destination datastore.

11. The method of claim 8, further comprising:
in response to determining that the second state snapshot comprises the number of changes to the source data less than the threshold, locking the source datastore from client access.

12. A system for copying a block of data, the system comprising:
a memory storage; and
a processing unit coupled to the memory storage, wherein the processing unit is operative to:
provide access from a client application to a plurality of data elements,
create a first state snapshot of the plurality of data elements on a first data storage device,
copy the plurality of data elements from the first data storage device to a second data storage device while continuing to provide access to the plurality of data elements from the client application,
create a second state snapshot of the plurality of data elements on the first data storage device,
determine, according to a comparison of the first state snapshot and the second state snapshot, whether more than a threshold number of modifications to the plurality of data elements occurred during the copy of the plurality of data elements from the first data storage device to a second data storage device, and
in response to determining that more than a threshold number of modifications to the plurality of data elements occurred during the copy of the plurality of data elements, copy the modified data elements from the first data storage device to the second data storage device while continuing to provide access to the plurality of data elements from the client application.

13. The system of claim 12, wherein the threshold number of modifications comprises 100 modifications.

14. The system of claim 12, wherein the processing unit is further operative to:
in response to determining that more than the threshold number of modifications to the plurality of data elements did not occur during the copy of the plurality of data elements, lock access to the plurality of data elements from the client application.

15. The system of claim 14, wherein the processing unit is further operative to:
determine whether a number of modifications to the plurality of elements less than the threshold number of modifications occurred during the copy of the plurality of data elements, copy the modified data elements from the first data storage device to the second data storage device while denying access to the plurality of data elements from the client application.

16. The system of claim 15, wherein the processing unit is further operative to provide access to the plurality of data elements on the second data storage device from the client application.

17. The system of claim 14, wherein the processing unit is further operative to:
in response to determining that more than the threshold number of modifications to the plurality of data elements did not occur during the copy of the plurality of data elements, determine whether a current time comprises a maintenance window time; and
in response to determining that the current time does not comprise the maintenance window time, continue to provide access to the plurality of data elements from the client application until the current time comprises the maintenance window time.

18. The system of claim 12, wherein the first state snapshot comprises at least one change number associated with at least one most recently modified element of the plurality of data elements prior to copying the plurality of data elements from the first data storage device to the second data storage device.

19. The system of claim 12, wherein the second state snapshot comprises at least one change number associated with at least one most recently modified element of the plurality of data elements after copying the plurality of data elements from the first data storage device to the second data storage device.

20. A computer-readable medium which stores a set of instructions which when executed performs a method for copying data with change synchronization, the method executed by the set of instructions comprising:
identifying a plurality of source data on a source datastore;
creating a first state snapshot of the source data;
determining, for each element of the plurality of source data, whether the element has been deleted since the creation of the first state snapshot;
in response to determining that the element has not been deleted, determining whether the element has been modified since the creation of the first state snapshot;
in response to determining that the element has been modified since the creation of the first state snapshot, copying the modified element to a destination datastore;
in response to determining that the element has not been modified since the creation of the first snapshot, copying the element as it exists in the first state snapshot to a destination datastore;
creating a second state snapshot of the source data;
determining whether the second state snapshot comprises a plurality of data elements greater than a threshold amount not present in the first state snapshot, wherein the threshold amount comprises at least one of the following: a number of the data elements and an amount of storage used by the data elements;
in response to determining that the second state snapshot comprises the plurality of data elements greater than a threshold amount not present in the first state snapshot, copying the plurality of data elements to the destination datastore;
in response to determining that the second state snapshot comprises the plurality of data elements less than a threshold amount not present in the first state snapshot:
locking the source datastore from further access by a client application associated with the source data,
copying the plurality of data elements to the destination datastore, and
directing the client application to access the destination datastore for interaction with the source data.
